(19) United States
(12) Patent Application Publication
(10) Pub. No.: US 2023/0136274 A1
(43) Pub. Date: May 4, 2023

(54) Ceph Media Failure and Remediation

(71) Applicant: SOFTIRON LIMITED, CHILWORTH (GB)

(72) Inventors: Gregory DuVall Bruno, San Diego, CA (US); Steve Hardwick, Austin, TX (US); Harry Richardson, Lamarsh (GB)

(73) Assignee: SOFTIRON LIMITED, CHILWORTH (GB)

(21) Appl. No.: 17/979,851

(22) Filed: Nov. 3, 2022

Related U.S. Application Data
(60) Provisional application No. 63/275,634, filed on Nov. 4, 2021.

(51) Int. Cl. H04L 67/1097; H04L 49/20

(52) U.S. Cl. CPC H04L 67/1097; H04L 49/205

(57) ABSTRACT

A server includes a processor and a non-transitory machine-readable medium. The medium includes instructions. The instructions, when loaded and executed by the processor, cause the processor to obtain software defined storage (SDS) performance data from a plurality of media servers, process the SDS performance data, and determine whether the SDS performance data indicates that a first media server includes a potentially failing storage medium.

### PRIORITY

The present application claims priority to U.S. Provisional Patent Application No. 63/275,634 filed Nov. 4, 2021, the contents of which are hereby incorporated in their entirety.

### FIELD OF THE INVENTION

The present disclosure relates to the management of computer servers and, in serial communications and, more particularly, to detection and remediation of software defined storage (SDS) such as Ceph and Ceph media.

### BACKGROUND

As the amount of data is constantly increasing, so is the need to utilize larger storage media devices. Consequently, storage media device failure has a greater impact as storage media devices become larger. To that end storage media device performance and monitoring data such as Self-Monitoring, Analysis and Reporting Technology (often written SMART) was developed to provide information used to predict drive failure. Many solutions use media performance and monitoring data alone to predict and remediate media failure.

Embodiments of the present disclosure may further utilize user data to aid in media failure predictions. In the case of SDS, system performance, checksums, error coding, or erasure coding errors can be used as a predictive factor. Using this predictive analysis, remediation can be conducted based on the potential failure of a storage media device.

In some cases, the predictions may generate false positives, wherein storage media devices are identified as potentially failing but that may not be the case. Using advanced testing with dynamic configuration, the false positive results can be evaluated and, if necessary, requalified.

Embodiments of the present disclosure address one or more of these issues.

### BRIEF DESCRIPTION OF THE DRAWINGS

FIG. 1 is an illustration of an example of the high-level construction of a storage media server, according to embodiments of the present disclosure.

FIG. 2 is an illustration of an exemplary system architecture for an error collection system for potential failure of media devices, according to embodiments of the present disclosure.

FIG. 3 is an illustration of data flow in a typical SDS architecture, according to embodiments of the present disclosure.

FIG. 4 is an illustration of corrective actions for a potentially failing storage media device, according to embodiments of the present disclosure.

FIG. 5 is an illustration of a flow chart for a replication algorithm, according to embodiments of the present disclosure.

FIG. 6 is an illustration of a graph showing the effect of a weighting change on a given object storage daemon (OSD), according to embodiments of the present disclosure.

FIG. 7 is an illustration of a graph showing an initial increase in processor usage when a given OSD is both receiving user data and transmitting backup data, according to embodiments of the present disclosure.

FIG. 8 is an illustration of a graph showing the effect of a data load on a destination storage media device such another OSD, according to embodiments of the present disclosure.

FIG. 9 is an illustration of a graph showing the effect of reducing weight for a potentially failing storage media device used by a given OSD, according to embodiments of the present disclosure.

FIG. 10 is an illustration of a graph showing a risk footprint and weight over time, according to embodiments of the present disclosure.

FIG. 11 is a physical representation of an intelligent storage media tray, according to embodiments of the present disclosure.

### DETAILED DESCRIPTION

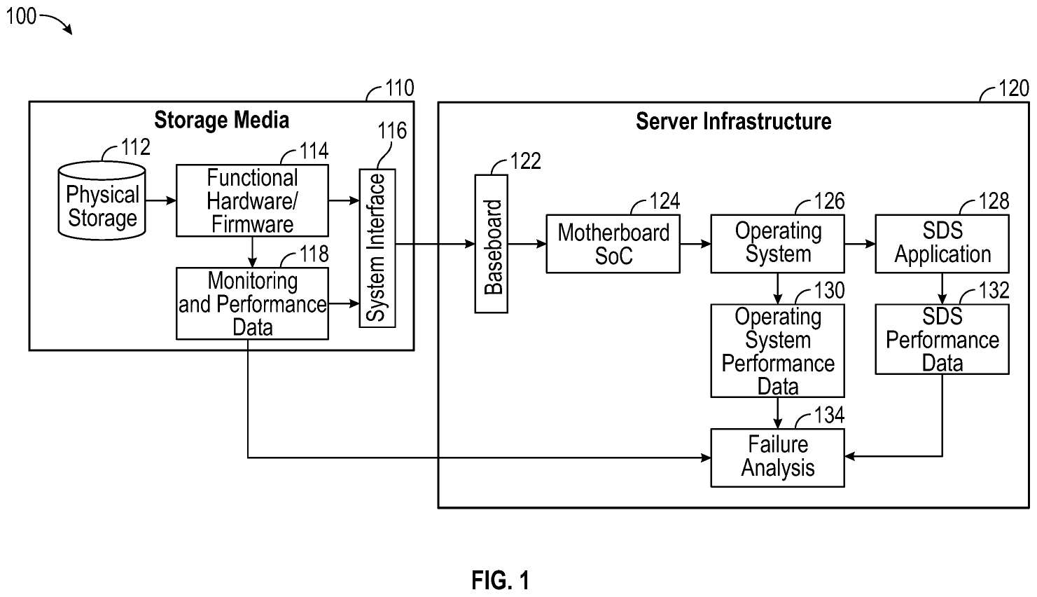

FIG. 1 is an illustration of an example of the high-level construction of a storage media server 100, according to embodiments of the present disclosure.

Server 100 may include storage media 110 and server infrastructure 120. From a general perspective, storage media 110 may contain a physical storage 112 component and functional hardware and firmware 114 that allow storage media 110 to provide storage capability. In addition, monitoring and performance data 118 may provide performance information about the operation of storage media. A system interface 116 may allow storage media 110 to communicate to server infrastructure 120.

Server infrastructure 120 may include any suitable number and kind of elements, some of which are shown. Server infrastructure 120 may include a System on a Chip (SOC) 124. A baseboard 122 may connect multiple storage media 110 devices, although only one is shown for clarity. SOC 124 may have an associated operating system 126 that may allow various applications to be executed. Once such application is an SDS application 128 such as Ceph. Operating system 126 may also generate operating system performance data 130. Similarly, SDS application 128 may also produce SDS performance data 132. In both cases, this may include items such as data throughput, computational execution times, system errors, and data errors.

The performance data can be used to provide predictive models to determine if a given storage media device has a potential to fail. FIG. 1 shows three potential sources for the performance data—monitoring and media monitoring and performance data 118, operating system performance data 130 and SDS performance data 132. The data can be used individually or in combination to provide different models for different purposes. The data may be analyzed by, for example, failure analysis 134.

The goal of the error analysis by failure analysis 134 may be to predict the potential failure of a storage media device 110 before catastrophic failure actually occurs in the device. If this prediction is achieved, then the media device can be identified and removed from service prior to catastrophic failure. Detection prior to failure may allow corrective action to be taken with respect to the user data. This may be especially true in SDS where information may be stored across multiple media devices. Further, SDS applications 128 may be designed to randomly and evenly distribute user data across multiple storage devices 110. Once an instance of storage media device 110 has been identified as predicted to fail, then it can be flagged for replacement. This may involve gracefully removing it from its operating environment, in that it is removed from its operating environment without causing needless accumulation of processing or storage load on other server assets. However, by using remediation, false positives can be detected and prevent the unnecessary removal of a functional storage media device.

In one embodiment, gracefully removing a flagged media device from its operating environment may include removing it while maintaining designed or intended duplication or backup, without causing undue burden on the system. The undue burden may be defined by an absolute quantity or percentage of server resources dedicated to backing up contents from the flagged media device. The undue burden may be defined by data transfer that is too slow or unacceptably long data queues.

Use of SDS may include mechanisms that collect SDS performance data. This can include, for example, user data transfer statistics and data integrity errors. In the case of transfer statistics, an error can be determined if the measured performance is outside of a given performance threshold, such as a slow data transfer of a given transfer or an unacceptably long data queue. Data integrity errors can be used as a detection mechanism. The errors may include, for example, checksums or hash codes of data blocks. These errors as well as data that does not conform to expected values, such as previously written values, may indicate a problem on the underlying physical media. Forward error correcting mechanisms or erasure codes, such as Reed-Solomon encoding, may be used to process the user data when it is written, and to detect errors in the returned data. However, in many media servers it is important to realize that performance variance could be attributable to any interface circuitry used to transfer the data to or from the storage media device. Thus, embodiments of the present disclosure may use analytical methods to extract the performance data for both the storage media devices alone, such as media monitoring and performance data and operating system metrics.

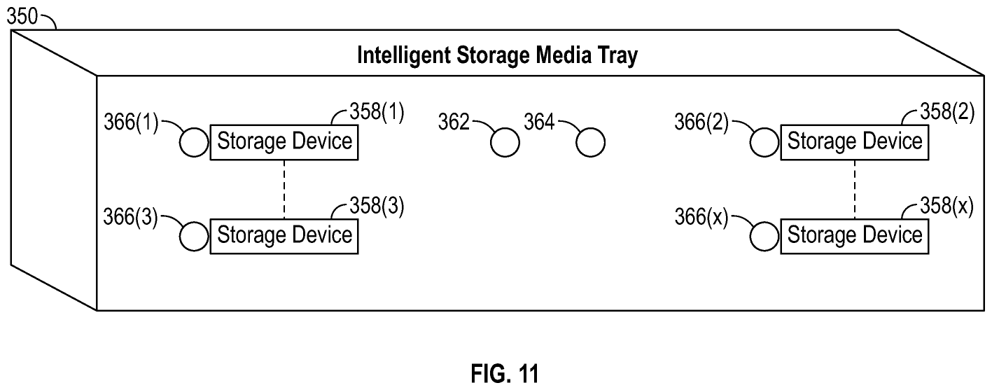

Storage media devices 110 may be physically located in a single assembly, such as a tray 350, illustrated in more detail in FIG. 11. In addition to containing the multiple storage media devices 110, there may also be a set of displays and a display controller. Displays may relate to the tray 350 and show the overall status of the assembly. The displays may relate to each individual storage media device and show the status thereof. SoC 124 can control these displays via the baseboard 122 and any suitable display controller.

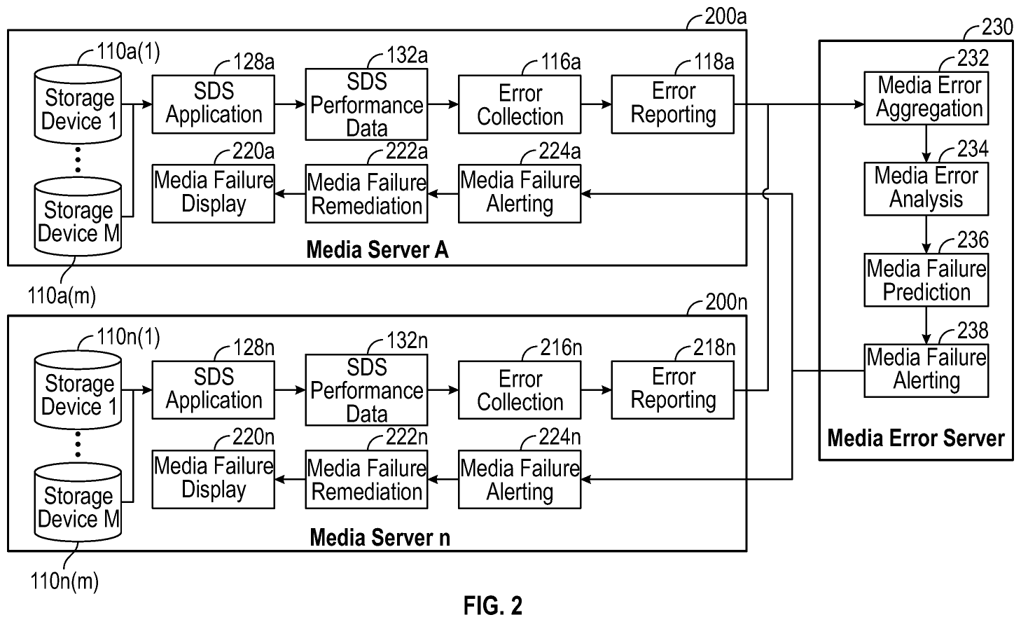

FIG. 2 is an illustration of an exemplary system architecture for an error collection system for potential failure of media devices, according to embodiments of the present disclosure. Various elements of FIG. 2 may include those that implement components of FIG. 1. The system may include a media error server 230 communicatively coupled to any suitable number of media servers 200. Media error server 230 and media servers 200 may be implemented in any suitable manner, such as by analog circuitry, digital circuitry, instructions for execution by a processor, or any suitable combination thereof. Media servers 200 may implement, fully or in part, server 100 of FIG. 1, or vice-versa.

A media error server 230 may communicate with any suitable number and kind of media servers 200. Each media error server 230 may be configured to perform error collection, error analysis, and error alerting. Moreover, each media server 200 may be configured to perform error collection, error analysis, and error alerting.

An SDS application 128 in each media server 200 may be executed on a SOC such as SOC 124 (not shown) and an operating system such as operating system 126 (not shown). SDS application 128 may be configured to use storage media devices 110 as part of its execution. SDS application 128 may perform data integrity checks to ensure the data read from storage media devices 110 matches the data written to storage media devices 110. The data integrity checks may include error checks, hashing and erasure encoding. When a read data error occurs, SDS application 128 may store a record of the failure event in SDS performance data 132. Furthermore, if SDS application 128 detects performance parameters that do not meet established limits, it can log an error in SDS performance data 132. An error collection application 216 can extract errors from SDS performance data 132 that are to be used for media failure predictions. Once collected, error reporting application 218 may transfer these errors to media error server 230 using any suitable network connection or other mechanism. The error data may be received by a media error aggregation 232 application in media error server 230. This application may collect error data from a plurality of media servers 200. The aggregation may include a database specifically designed for error collection. This may give a large sample of error data from multiple media servers 200.

Media servers 200 may be connected to a media error server 230 using any suitable network connection, which may allow the media error analysis to be accomplished without adding any processing overhead onto media servers 200 themselves. First, data may be aggregated from multiple media servers 200 using media aggregation application 232. The errors from each individual media server 200 may be collected and aggregated. For example, error data may be collated by error type and errors may be ordered by time received. This may provide a data source for a media error analysis 234 module on error server 230.

Media failure prediction may include the task of identifying systems which are likely to fail in the future based on historical trends, data, and usage statistics collected from similar systems. Generally, a data ‘training set’ including media error data may be collected. A model, or series of models can be built for the purpose of providing predictive results. The training data may be used to be able to heuristically tune the model to give accurate results, such as reducing false positives and negatives. A false positive may be a prediction that a storage media device is potentially failing, when in fact it is not. A false negative may be a lack of an indication of a storage media device that is actually failing.

Since these models may be dependent upon statistical analysis over time, media error aggregation module 232 may be responsible for aligning the local timestamps from each media server error collection module 216. These may be grouped into a time interval to account for minor time differences between the servers. Media error analysis module 234 may perform this grouping. Consequently, when a specific media server 200 or storage media device 110 experiences a failure, that failure may be recorded and associated with that specific media server at a particular timestamp. A failure prediction application may be trained to learn this relationship using machine learning.

Media failure prediction module 236 may analyze the data provided by media error analysis module 234 at frequent, regular intervals. Based on historical trends, data, and usage statistics collected from this data, a value for each storage media device storage media device 110 and media server 200 may be generated. This value may provide a probability of failure for each of these items.

Storage media device failure prediction has previously been performed using exclusively media monitoring and performance data attributes. Specifically, SMART attributes have been used, including those representing reallocated sectors count, reported uncorrectable errors, command timeout, current pending sector count, and uncorrectable sector count. Using solely internal storage media monitoring data attributes may be limited because it exclusively considers defects occurring inside the media. For example, this medium does not include failures arising from the system interface to media devices. This limitation can be removed by adding additional media error data to improve the predictive models.

As mentioned earlier, the amount of information provided to the model may increase its accuracy and lower the number of false positives and negatives. To this end, the traditional data sources such as storage media monitoring and performance data (such as 118) and operating system performance data (such as 130) may be augmented with SDS performance data (such as 132). SDS application 128 may provide data integrity measurements, from detected errors, in addition to performance at the user data level. Another advantage may be that, by design, an SDS application may be built to pseudo-randomly place data across the various storage media devices 110 and also within each storage media physical storage 112 location. This may provide a better statistical model for media failure prediction module 236 than other models. This failure prediction application may be informed by a larger amount of data collected from past historical failures, and ‘trained’ to reproduce the mapping from media error data to an estimated time-to-failure.

Some examples of additional media error data may include those reported by a SDS application 128 such as summary statistics like data throughput rate, file system errors, user data errors, and results from automated disk check tests for throughput accuracy mentioned later. This data may be recorded in a time-series that joins a particular storage media device 110 and be timestamped together with the additional media error data as previously described above.

The failure probability for each storage media device storage media device 110, media server 200, and placement group may be provided by media failure prediction module 236 to media failure alerting module 238. The output of media failure prediction application 236 may be the estimated time to failure for a particular media storage device or media server. Devices with a shorter time to failure can be interpreted as having a greater risk footprint and are expected to fail sooner. Predictions can be performed at an arbitrary, but regular, frequency, and media storage devices which are consistently predicted to fail are more likely to fail. Predicted values can be measured against a set of predefined thresholds by media failure alerting module 238. These may be instantaneous thresholds or measurements aggregated over a specified time interval, and may include, for example, an estimated time-to-failure (TTF). Continuous assessment of time to failure of a drive—that is, the longer it is marked as potentially failing—may affect the risk value. Using this measurement, a risk footprint for each of the above-mentioned items can be produced. Further if these exceed a set threshold, then an alerting message can be sent to the specific unit with an excessive risk footprint.

The result of the data analysis may be provided to media failure prediction application 236. This may detect if a specific media device 110 in a specific media server 200 is a potentially failing device.

Media failure prediction application 236 may provide information regarding potentially failing media devices 110 to a media failure alerting application 238. Failure prediction data can be aligned to a specific storage media device 110 and media server 200. Media failure alerting application 238 may send this information to the respective media server 200 using an external network connection or any other suitable communication protocol. A corresponding application, media failure alerting application 224, may be included in each media server 200. The local media failure alerting application 224 may trigger any suitable corrective actions or sets of responses based upon the information that it has received. For example, media failure remediation application 222 may alert users or administrators that an error is likely to occur. Application 222 may set various elements of a media failure display 220, such as LCDs, LEDs, or other displays with error codes or any suitable indicator than error has occurred, on the outside of the respective server.

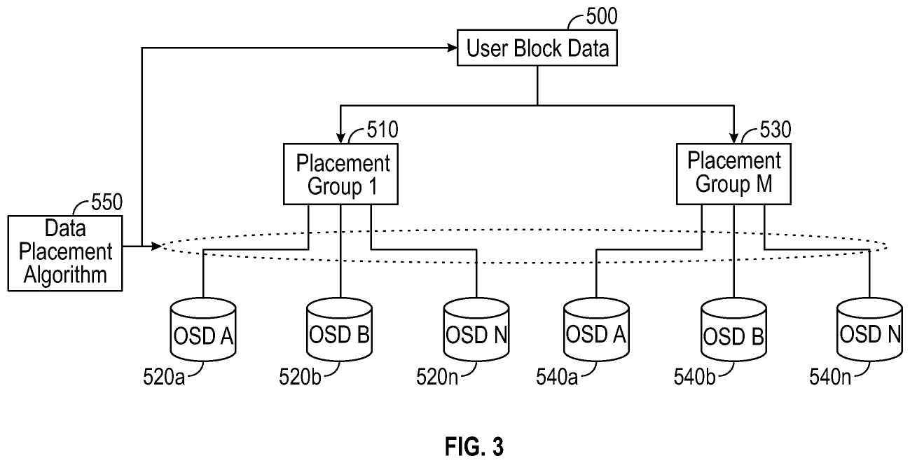

FIG. 3 is an illustration of data flow in a typical SDS architecture, according to embodiments of the present disclosure. Ceph has been used as an exemplary architecture of an SDS to provide a clearer description of the functionality of an SDS solution, although embodiments of the present disclosure may include any suitable SDS. The data flow may represent, for example, execution of SDS application 128.

SDS application 128 may break down possible storage locations of storage media devices, such as devices 110, into placement groups (PGs). A PG may be a logical collection of objects that are replicated on OSDs. The replication of the objects of a given PG onto multiple such OSDs may provide reliability in a storage system.

Each PG may be assigned a unique value for use by the set of SDS applications 128. A data placement algorithm, such as CRUSH, may assign the PG to a specific OSD, which is the primary OSD. Multiple PGs can be assigned to a single primary OSD. OSDs in turn may predominantly assigned in a one-to-one relationship with a storage media device. Some very small systems may have multiple OSDs per storage media device, but this configuration might not be recommended. The OSD may then define additional OSDs that are to be used for data replicas, or backups.

Consequently, many data objects might be mapped to a given PG. Each individual object might be mapped to a single PG. A given PG may be mapped to a list of OSDs, wherein the first OSD may be a primary OSD and the remainder OSDs may be backups.

Using the CRUSH algorithm, a cryptographic hash value can be calculated from the user data object name or other characteristics. This hash value may be used to select the PG used to assign the storage location for the user data object. The user data object may be routed to the selected PG and corresponding primary OSD. Once stored in the primary OSD, replicas of the data may be made on the secondary, tertiary, quaternary, or subsequent OSDs and their corresponding storage media devices. During the normal course of operation, the PGs can be reassigned to different OSDs, especially when new OSDs, and corresponding storage media devices, are added. This process may be referred to as balancing the storage cluster. It can be, for example, a result of the failure of an OSD, or when a new data replica needs to be created. In addition, the data placement algorithm may create new PGs and assign them to new or existing OSDs.

One challenge may be that the storage capability of a storage media device 110 may vary from device to device. In one embodiment, the concept of OSD weight can be used to accommodate this. A lower OSD weight may result in fewer PGs being assigned to the OSD, and consequently less data being routed to the corresponding storage device. If an OSD weight value is changed, the data placement algorithm may adjust the number of PGs assigned to it. For example, lowering an OSD weight may result in the reduction of the number of PGs that are assigned to the OSD, and hence reduce the amount of data that is directed to that OSD and attached storage media device. Furthermore, as the PGs are disassociated from the OSD, the SDS application may make additional replica copies of the data associated with the PG that has been moved.

In FIG. 3, user block data 500 may be broken down into objects. Data placement algorithm 500 may be implemented by, for example, CRUSH. Algorithm 550 may compute the hash value using the object name. Using this value, data placement algorithm 550 may route the object to a specific PG such as 510 or 530. The data may then be passed to the primary OSD, which may be OSDA 520a for placement group 1 510 or OSD A 540a for placement group M 530. The primary OSD may then create replicas in the subsequent OSDs—OSDB 520B through OSDN 520N for OSDA 520A, or OSDB 540B through OSDN 540N for OSDA 540A. The replica set that is attached to a PG may be called an acting set. OSDA 520A, OSDB 520B, and OSDN 520N may represent the acting set for PG 1 510. Similarly, OSDB 540B and OSDN 540N may represent the acting set for PG M 530. Each OSD may typically be associated with an individual storage media device. Therefore OSDs 520 and 540 can be associated with any of the storage media devices 110.

SDS application 128 may also ensure that a new OSD selected to replace a potentially failing OSD is not in itself potentially failing. The target OSD may be be a member of several existing PG acting sets. As such SDS application 128 may compute the aggregate risk of all the existing PGs and determine the subsequent risk value of the OSD. Consequently, SDS application 128 may select an OSD with a low risk factor as the destination of the PGs that are to move from the OSD associated with a potentially failing storage media device. This calculation can be made each time the weight is reduced or otherwise adjusted, such that as each group of PGs are relocated a new OSD may be chose as a replacement in its acting set.

Because of the hash value used to locate the PG, the user data is pseudo randomly distributed to multiple location in the storage cluster. Moreover, backup copies of the user data are automatically created.

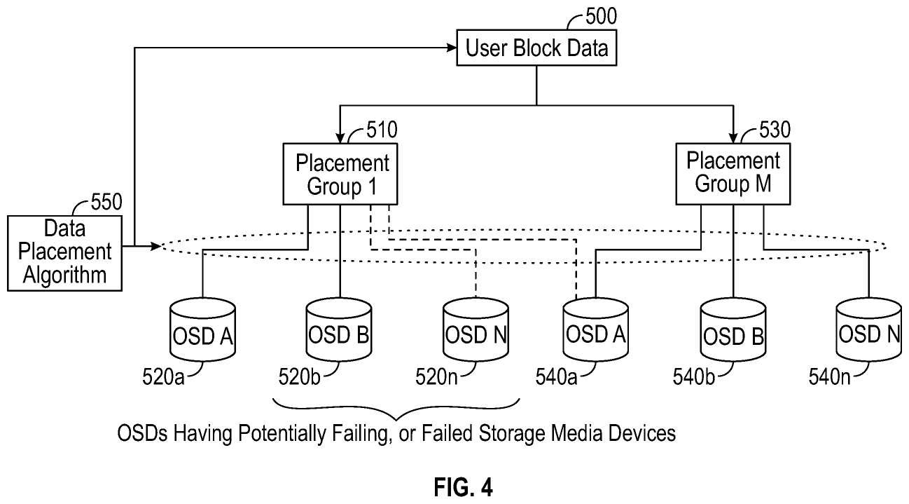

FIG. 4 is an illustration of corrective actions for a potentially failing storage media device, according to embodiments of the present disclosure.

FIG. 4 shows similar architecture to FIG. 3 with the exception that storage devices 520b and 520n have been identified as potentially failing. As mentioned earlier, media failure alerting application 238 in media error server 230 can send an alert to a media failure alerting application 224 in a given media server 200.

In a simplified view, data placement algorithm 550 (such as a CRUSH map algorithm) determines how storage blocks may be allocated and replicated across the entire set of storage media devices 110 using their respective OSDs 520 and 540. Data placement algorithm 550 can allocate a weight value to each storage media device 110. The weight value may influence how user data is routed to each storage media device 110. A storage media device with a “heavier weight” may have more user data blocks 500 routed to it than a storage media device with a “lower weight”. Additionally, using the placement groups 510 and 530, replicas of the user data may be created on multiple media storage devices 110. FIG. 3 shows each placement group 510 and 530 with multiple OSDs and therefore storage media devices attached. This would allow up to N replicas to be stored. In a typical configuration, three OSDs would be attached to a placement group, allowing three replicas to be stored.

When a storage media device 110 fails, the SDS system can normally accommodate the failure through remediation. If one or more storage media devices 110 within a PG acting set fail, then replicas of the user data can be copied onto the new replacement storage media devices using OSDs. This can be accomplished as long as a replica is available. As the number of functional storage media devices in a placement group becomes reduced, e.g., through multiple storage media failures, then there is an increased risk footprint that the last replica set may be lost and the user data cannot be recovered. Embodiments of the present disclosure may proactively remediate the risk footprint during the case that multiple storage media devices from the same replication group are identified as potentially failing or have already failed, such that user block data 500 can be replicated prior to a catastrophic failure event, such as wherein no replica data is available.

FIG. 4 is exemplary of a system where there is an increased risk footprint. OSD B 520B and OSD N 520N, together with their associated storage media devices 110 may be identified as potentially failing. This may leave only OSD A 520A and its associated storage media device 110 as the only replica source for placement group 1 (510) if the potentially failing storage media devices actually fail. As such, PG 1 510 may have a very high risk footprint as only one replica set exists on a storage media device 110 that is not otherwise identified as potentially failing. Fortunately, because such a storage media device 110 is only potentially failing, i.e., has not yet failed, a user data acting set is still available on that storage media device 110 for usage (and in particular, transferring data to another storage media device 110) as long as it remains functional. The risk footprint value may change as the number of functioning, potentially failing, and failed storage media devices 110 vary. The longer a storage media device 110 remains marked as potentially failing, the higher probability that it will fail and subsequently its risk footprint value may be increased. The risk footprint may also take into consideration the amount of time a storage media device has been identified as potentially failing or time to failure. This may ensure that there is enough time to copy over the user data replicas. Remediation can be triggered by setting a threshold value for the placement group risk footprint.

Once it has been identified that there is a high risk footprint value for a given device 110, remediation may be triggered. To reduce the risk footprint, another copy of the user data replicas may be created on a known good storage media device 110 to receive data from a potentially failing storage media device 110. As mentioned earlier, data placement algorithm 550 can directly influence the placement of user data blocks within the SDS application 128. Algorithm 550 may slowly decrease the weight of one of the potentially failing storage media devices, which in turn may cause data placement algorithm 550 to redistribute user data blocks 500 from the potentially failing storage media device 110 to a known good storage media device 110. The weight may determine how many PGs associate with the OSD using the potentially failing media device 110 are moved to other OSDs. The greater the change in OSD weight, the larger the numbers of associated PGs may be moved. PGs that have not been moved may still continue to receive new user data. Consequently, the rate of OSD weight change may also determine the amount of new user data that is copied to the storage media device 110. The speed at which the rate is changed may drive the amount of additional systems resources to accomplish the redistribution. Consequently, the rate at which the weight is changed may remain gradual to reduce the server processing load on the server containing the storage media device 110 relinquishing the data and the server containing the storage media server 110 receiving the data. Conversely as the risk footprint increases the rate of weight change may be increased to ensure that the replicas are copied while they still exist, and before any estimated failure. Since this is a very dynamic process, a replication algorithm, described later, is used to accomplish this.

In placement group 1 510, OSD B 520B through OSD N 520N, and their associated storage media devices 110 are shown as potentially failing or already failed storage media devices. As such the risk footprint of placement group 1 510 may be very high and trigger remediation actions. OSD N 520N, and its associated potentially failing storage media device 110, may be the source of the user data replica set. A new set of user data replicas may be created on a different placement group, such as placement group M 530. Prior to reallocating a new OSD to PG1 510 acting set, SDS application 128 may identify a storage media device 110 that has a low risk of failure. Consequently, OSD A 540A, and its associated known good storage media device 110, can be used. A risk mitigation algorithm can use the data placement algorithm 550 to relocate blocks from OSD N 520N in placement group 1 510 to OSD A 540A in placement group N 530. As mentioned earlier this can be accomplished by changing the weight of the storage media device 110, associated with OSD N 520N. Once all the user data replicas have been moved from OSD N 520N to OSD A 540A, placement group 1 510 may have a second set of user data replicas, now located in OSD A 540A. This may reduce the risk footprint of placement group 1 510. Further, since all of the user data has been moved from OSD N 520N, the potentially failing device may be effectively isolated and can be marked as potentially failing so that further remediation action can be taken.

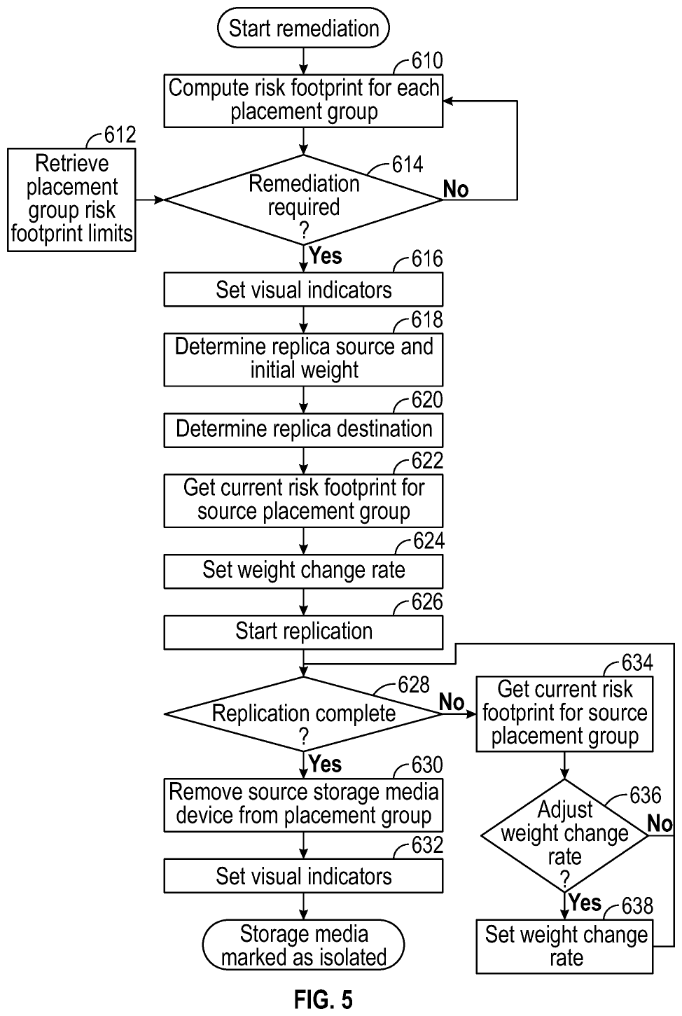

FIG. 5 is an illustration of a flow chart for a replication algorithm, according to embodiments of the present disclosure. The replication algorithm may be used to move user data replicas from a potentially failing storage media device 110 to a known good storage media device 110.

At block 610, a risk footprint may be computed for each placement group (such as PGs 510, 530) by media failure prediction application 236. This may take into consideration: percentage of functional storage media devices; time to catastrophic failure, which may be the time when the limit of functional storage media devices is available is reached; and amount of data to be replicated. The calculation could include the product of the above parameters:

PGR=(Number of OSDPF/Number of OSDAS)*(TTX/TCF)*(DR/DT)

Wherein PGR is the calculated risk foot print for a placement group; OSDPF is the number of OSDs in the acting set that have either failed or are potentially failing; OSDAS is the total number of OSDs in the PG acting set; TTX is the amount of estimated time to transfer all of the remaining data from the source OSD; TCF is the amount of time before critical failure; DR is the total amount of data in the OSD for the PG that is remaining to be transferred, including the data associate with the PGs that are not being transferred; and DT is the amount of data in the OSD when the PG reallocation was started.

For each potentially failing storage media device 110, an estimate may be provided on when there is a high probability that the device will fail or time to fail. Therefore, a timeframe can be computed to when the last potentially failing storage media device will most probably fail. The time to catastrophic failure may be when the last potentially failing storage media device fails and the limit of functional storage media devices available is reached. For example, OSD B 520B may have a time to failure of 94.3 hours and OSD N 520N may have a time to failure of 47.5 hours. This gives a time to failure of 94.3 hours before OSD A 520A has the only copy of the data. The storage device 110 associated with OSD N may have a capacity of 452 GB. The average transfer speed of the storage device attached to OSD N may be 10 Mbs.

This would require 12.5 hours to move all of the data for all of the PG on the storage media device. The number of potentially failing or failed OSDs is two and the total in the acting set is three. The amount of data to be transferred is 452 GB and is the same as the amount remaining. This would give a PG risk value as follows

PGR=(2/3)(12.5/94.4)(452/452)=0.08

Consider a time period 5 minutes later. In addition to data being transferred from OSD N due to the reallocation of PG1, there may also more data being added due to the other PGs that are not being moved. The incoming data rate may vary as user data is supplied to SDS application 128.

Incoming data added to the storage media device may be 6.08 GB. The amount of data that was transferred during that time period may have been 1.88 GB. This may result in a net add from the original data amount of 4.2 GB. This may result in 458.2 GB. The time to transfer this amount of data may be 12.55 hours. The amount of time to critical failure may be 94.4-0.08=94.2 (rounded)

The new risk value is

PGR=(2/3)(12.55/93.3)(458.2/452)=0.09

Thus, the risk factor has increased due to the fact that more data is being written to the existing PGs versus the data being removed from the relocated PG.

At block 612 the limits for each placement group 510, 530 risk footprint is retrieved.

At block 614, the current risk footprint is obtained for each placement group 510, 530 and compared against its retrieved limit. If the current value is less than the limit, then block 610 may be executed and an execution loop may be performed that may continually evaluate the risk footprints of all placement groups. If the current value is equal or exceeds the limit, then remediation is needed and block 616 may be executed.

At block 616, once remediation has been started, the motherboard SoC 124 can set visual indicators or displays to indicate which storage media device 110 is being replicated. Further visual indicators or displays can show which intelligent storage media tray 350 contains this specific storage media device 110.

At block 618, the various storage media devices 110 may be evaluated for any placement group requiring remediation.

A replica source can be chosen from the active set of the PG attached to the OSD of the potentially failing storage media device. Since there may be more than one, the following criteria can be used to select the best candidate.

First, a minimum number of PGs attached to the OSD may be considered. More PGs may result in more data being written and read from the storage device. The higher number of PGs may result in less bandwidth for data backup operations for the ones that need to be moved.

Second, current probability of failure of the storage media device (time to critical failure) may be considered.

Third, the estimated time to transfer all of the remaining data from the source OSD may be considered.

The calculation may be given as

OSDS=NPSPG*(TTX/TCF)

where OSDS is the calculated risk footprint for a source OSD; NPSPG is the total number of PGs attached to the source OSD; TTX is the amount of estimated time to transfer all of the remaining data from the source OSD; and TCF is the amount of time before critical failure of the source OSD. The lower the value of OSDS the better the candidate.

As described earlier, changing the weight of an OSD may result in the movement of PGs from an OSD. The initial weight change may depend on the number of PGs that need to be transferred. This may be determined by various mechanisms. For example:

WINIT=1−(NPSPG/100).

This initial weight, WINIT, may be assigned to the respective OSD by the data placement algorithm 550.

At block 620, a suitable destination storage media device 110 may be selected. A similar calculation in step 620 can be used to determine an optimal candidate among available devices 110 as follows

OSDD=NPDPG*(TTX/TCF)

where OSDD is the calculated risk foot print for a destination OSD; NPDPG is the total number of PGs attached to the destination OSD; TTX is the amount of estimated time to transfer all of the remaining data from the source OSD; and TCF is the amount of time before critical failure of the destination OSD. The lower the value of OSDD for a given media device 110, the better that media device 110 is as a candidate.

It may be the case that SDS application 128 may use the OSDD value select a destination ODS using data placement algorithm 550, as is the case in Ceph.

At block 622, the risk footprint of the source placement group that is to be replicated may be evaluated, as the risk footprint may change since it was measured in step 610 due to the amount of time that has elapsed.

At block 624, using the risk footprint value from block 622, the rate of change of the weight value from the source storage media device may be set. The rate of weight change may be a function of the amount of time required to transfer the user data replicas compared with the amount of time before catastrophic failure. The rate of change can be calculated as follows:

mWINC=(TCF−TTX)/(WINIT*WDF)

where WINC is the time interval to decrease the weight by 0.01. WDF is the weight decay factor which will control the overall time needed to remove all of the data from the storage device. WDF can ensure that the amount of time needed to remove the data is significantly less than TCCF and provide a buffer margin for the OSD to be removed from the SDS cluster.

After the weight is set to WINIT on OSD N 520N, the incoming data to placement group 1 may be partially routed to OSD A 520A, OSD B 520B and OSD A 540N. Placement group 1 510 may still send a portion of the user block data to OSD N 520N. Using a known good storage device 110 as the source may increase the amount of activity on such a storage device 110 since the storage device 110 may still be receiving new user data routed to the PGs that are not being relocated. The additional new user block data from placement group 1 510 and the backup data from OSD N 520N may be an additional data load for OSD A 540A. Overall system usage is directly proportional to placement group risk footprint. Using the failing drive as a replica source may help to minimize system resource use and consequently placement group 1 risk footprint. However, the additional data load may increase the risk footprint on placement group M 530 as it may increase storage media device and processor utilization.

At block 626, the user data replicas may begin to be transferred from the source storage media device in 520N to the destination storage media device in 540A, denoted by the dotted lines in FIG. 4.

At block 628, the replication action may be evaluated to determine if all of the user replica data has been successfully transferred, i.e. no Placement Groups remain associated with the potentially failing OSD. If it has not, then the replication process may continue and block 634 may be executed next. If all data has been transferred, then the source storage media device can be detached as it has no further active role in SDS application 128.

At block 630, the source storage media device associated with the replicated OSD N 520N can be detached from SDS application 128. No further data may be transferred to or from the source storage media device. Placement group 1 510 may use OSD A 540A for user data storage. This may isolate the storage media device associated with OSD N 520N such that further remediation actions can be taken.

At block 632, once the isolation of the OSD 420N has been completed, the motherboard SoC may set displays or indicators to indicate which storage media device 110 has been isolated. Further visual indicators or displays can show which intelligent storage media tray 350 contains this specific storage media device 110.

At block 634, the risk footprint of the placement group containing the replication source storage media device may be re-evaluated. Several factors may have changed since the last evaluation. The factors may include the amount of data yet to be replicated, an increased probability that the potentially failing storage media device may completely fail, and system load in the SDS application containing the source placement group and the destination placement group.

At block 636, using the current source placement group 510 risk footprint obtained in block 634, the rate of change of weight may be evaluated. Other factors, such as destination system load and destination storage media availability, may be used to evaluate the rate of change in the weight value. If a change is needed, then block 638 may be executed. If not, then block 628 may be executed. This may form a loop to continually evaluate the rate of weight change until the replication is completed.

At block 638, the rate of weight change may be made. This can either be a positive or negative adjustment in weight change rate.

The rate of change can be calculated as follows

WINC=(TCCF−TCTX)/(WCUR*WDF)

where WINC is the time interval to decrease the weight by 0.01 (this new time interval may be greater than or smaller than the current value); WCUR is the current weight of the source OSD; TCTX is the current amount of estimated time to transfer all of the remaining data from the source OSD; TCCF is the current amount of time before critical failure of the destination OSD; and WDF is the weight decay factor which will control the overall time needed to remove all of the data from the storage device. WDF can ensure that the amount of time needed to remove the data is significantly less than TCCF and provide a buffer margin for the OSD to be removed from the SDS cluster.

Once the change has been made, block 628 may be executed next. This may form a loop to continually evaluate the rate of weight change until the weight reaches zero.

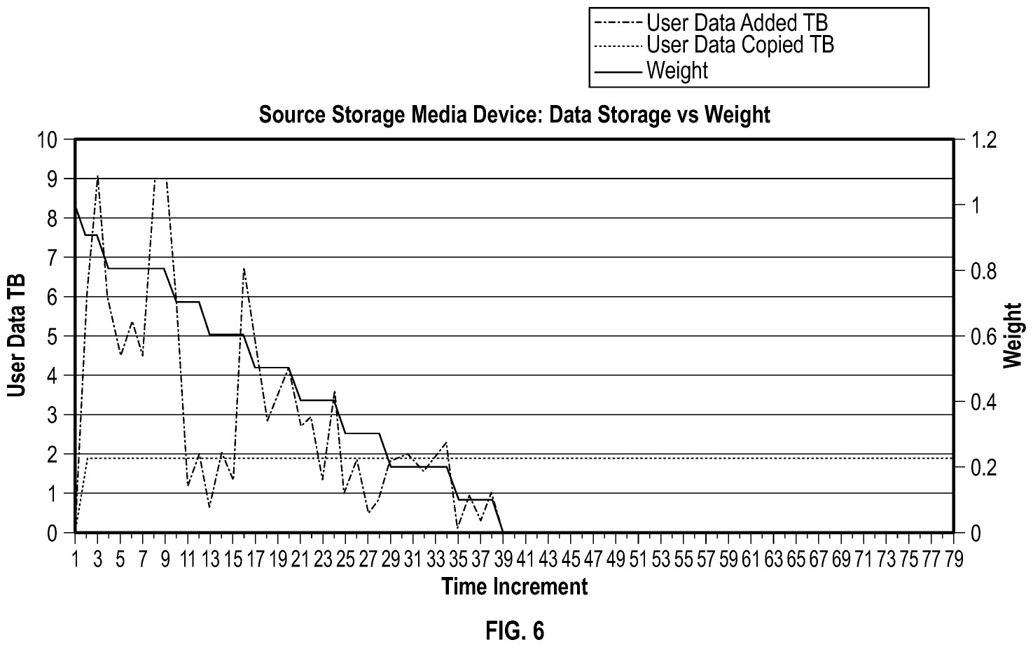

As mentioned earlier, the process of adjusting the weight of the potentially failing storage media device may be a very dynamic process. This may be further complicated due to the randomness of the data rates of the user data. Therefore, it may be difficult using other solutions to directly calculate the rate to reduce the weight of the potentially failing storage media device. Instead, the algorithm in FIG. 4 may be used to address one or more of these issues. An exemplary model of the expected behavior of the algorithm follows in FIGS. 6-10 to illustrate this dynamic behavior.

The graphs in FIGS. 6-10 discussed below show measurements in an exemplary system that are taken every 5 minutes. These graphs may indicate the effect of the weight change on the CPU load, for both source 520N and destination 540A storage media devices and the risk footprint of placement group 1 510 containing the potentially failing storage media device. In addition, this shows the effect of that weight change on placement group M 530 containing the potentially failing storage media device replacement.

FIG. 6 is an illustration of a graph showing the effect of a weighting change on a given OSD, according to embodiments of the present disclosure.

The graph shows the effect of the weighting change on OSD N 520N. The SDS system may use the weight to alter the amount of data sent to OSD N. Consequently, as the weight for OSD N reduces the amount of new data added to the drive decreases. Also shown is the data that is moved off the drive by the replication action. Initially, this may cause increased processor usage. However as, the weight decreases the overall data rate may decrease, along with the processor load.

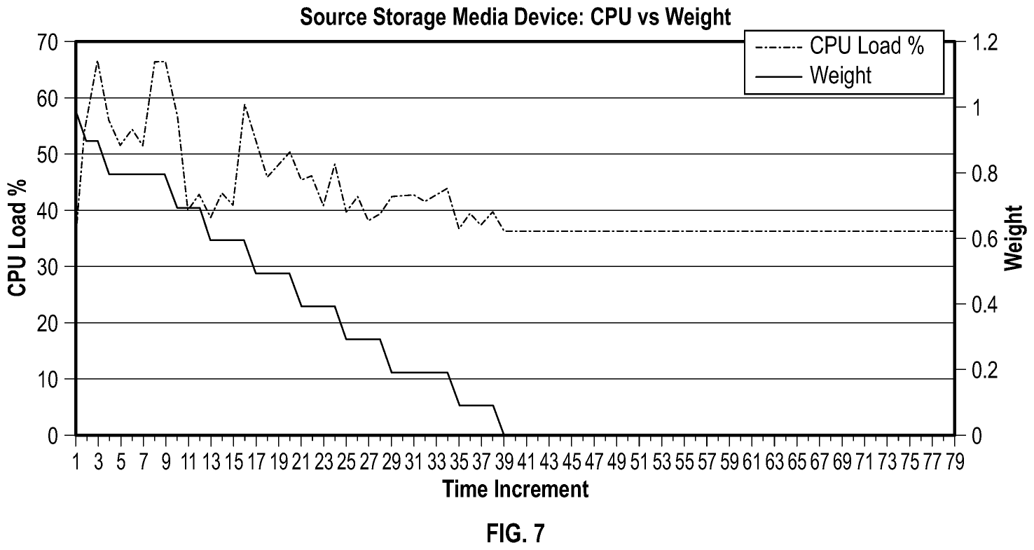

FIG. 7 is an illustration of a graph showing an initial increase in processor usage when a given OSD is both receiving user data and transmitting backup data, according to embodiments of the present disclosure.

As mentioned earlier, as the weight is decreased the incoming data load decreases to zero. This results in only the transfer of backup data loading the processor. Further, the load placed on the processor by the transfer of backup data cannot create CPU usage values that are outside acceptable limits.

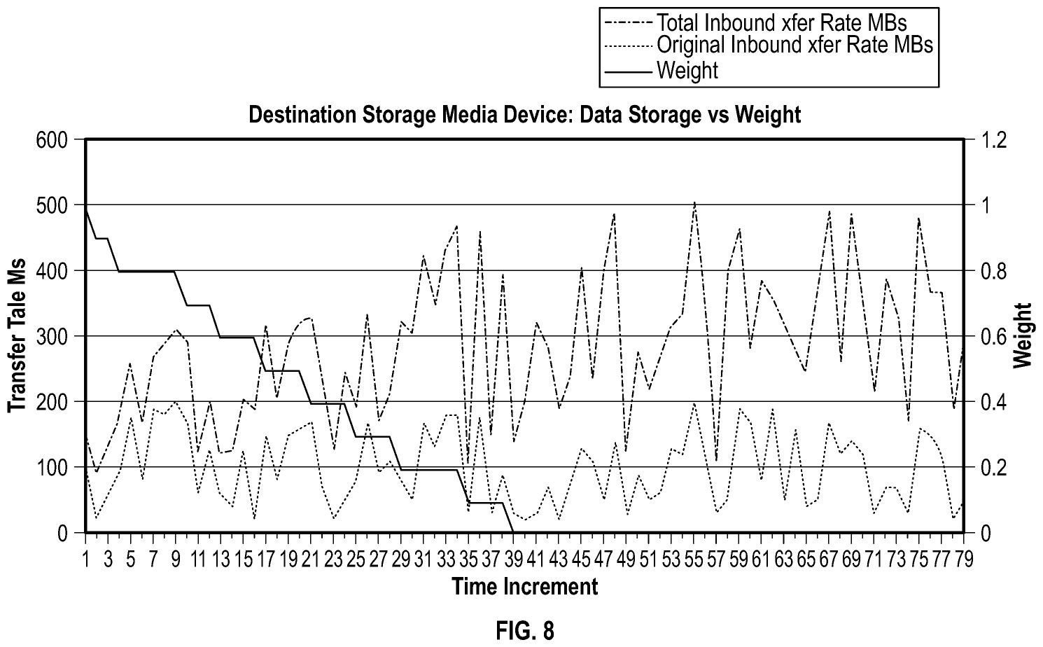

FIG. 8 is an illustration of a graph showing the effect of a data load on a destination storage media device such another OSD, according to embodiments of the present disclosure.

The data load on the destination storage media device, OSD A 540A, is quite different from the source storage media device, OSD N 520N. As the weight is decreased on the source storage media device, additional user data from placement group 1 510 is added, in addition to backup data from OSD N 520N. This may add to the user data that is already coming from placement group M 530. This is signified in FIG. 4 by the dotted line to OSD A 540A from placement group 1 510 and solid line from placement group M 530, respectively. The total amount of incoming data on OSD A 540 may increase until the weight has reached 0. At that point, all of the user data from placement group 1 may have been routed to OSD A 540A. Similarly, there may be an additional load from the backup data transfer from OSD N 520N until that is completed.

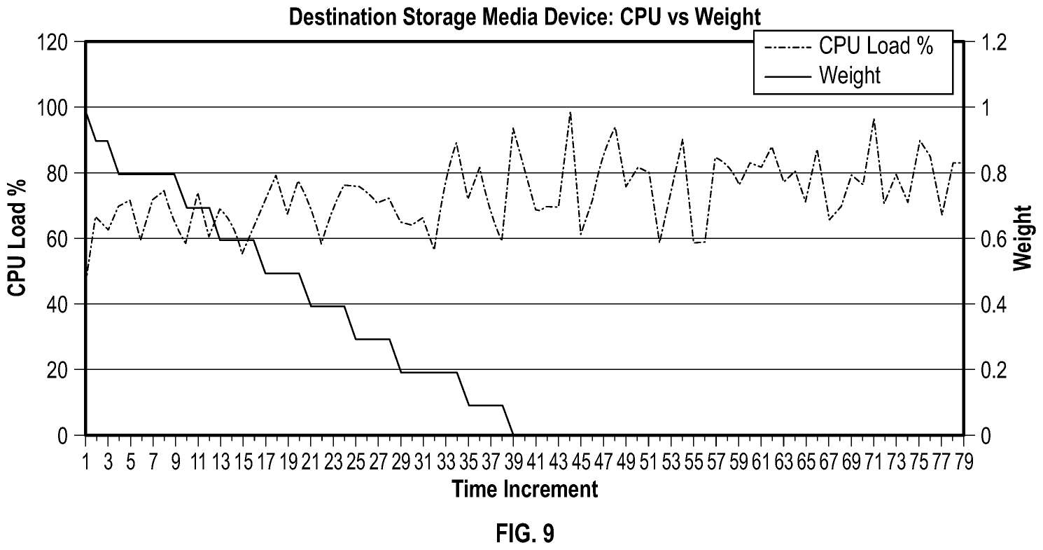

FIG. 9 is an illustration of a graph showing the effect of reducing weight for a potentially failing storage media device used by a given OSD, according to embodiments of the present disclosure.

As can be seen from the graph as the weight reduces for the potentially failing storage media device used by OSD N 520N, it may increase data load on the destination storage media device, OSD A 540A. This may increase the processor usage for the destination storage media server. The speed at which the data is backed up from OSD N 520N may be at a level that does not force the processor in OSD A 540A to move into an unacceptable usage level, such as, for example, 95%. As can be seen from the graph, the CPU usage does get very high, above 95%, but only for a short period of time. This may be deemed acceptable. If this needs to be corrected, the data backup transfer speed from OSD N 520N could be reduced. However, this would increase the risk footprint of placement group 1 510 due to the longer amount of time to transfer the data, as will be shown later.

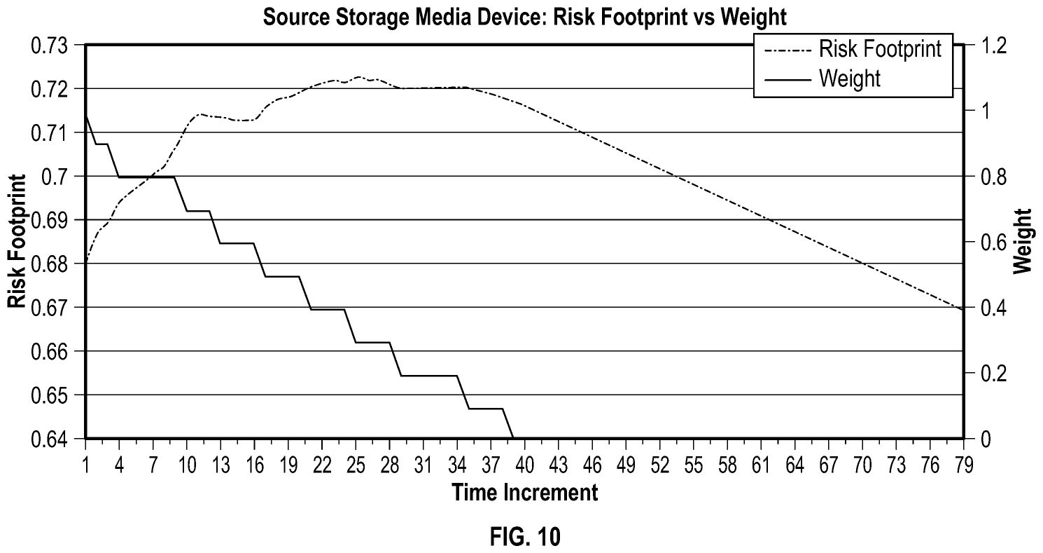

FIG. 10 is an illustration of a graph showing a risk footprint and weight over time, according to embodiments of the present disclosure.

The risk footprint is directly proportional to the amount of time needed to move all of the user data, divided by the amount of time to failure for the storage media device.

Risk footprint∝(U_{d}÷R_{b})÷SD_{mttf}

where U_{d} is the amount of user data contained on the Storage device; R_{b} is the transfer data rate of the backup data; and SD_{mttf} is the mean time to failure of the storage device contained the user data.

In this graph, the effect of the weight change can be seen on the risk footprint for placement group 1 510. The risk footprint is directly driven by the amount of time it will take to remove all user data from the potentially failing storage media device for OSD N 520N. The goal is to ensure all data is removed prior to the predicted failure time of the penultimate drive in the placement group. Initially there is an accumulation of data stored by OSD N 520N due to the fact that the backup data rate is lower than the user data rate. As the weight is reduced the user data rate to OSD N 520N may also drop, eventually to zero. This is shown in the graph of FIG. 6. Since additional data is being added to the drive the amount of time to back up all the data increases. This may increase the risk footprint, as shown in FIG. 5. Eventually, as the amount of user data decreases due to the weight decrease, the amount of time to back up the data may decrease. This is shown in a downward trend in the risk footprint. Once the weight has reached zero, the risk footprint may continue to decrease. When all of the data has been backed up from OSD N 520N, then the risk footprint may be at zero also.

Increasing the backup data rate may reduce the initial risk footprint increase and alter its rate of decay. However, looking at the graph of FIG. 9, increasing the backup rate could increase the load on the OSD A 540A processor. This may create a dynamic balancing challenge between decreasing the weight or increasing the backup data rate versus ensuring an acceptable CPU usage for OSD A 540A. In the example shown, these rates were optimized to give the fastest risk footprint decay that the processor usage on OSD A 540A would allow.

Once the storage media device has had all of its data backed up, it may be removed. A new storage media device can be added to replace the potentially failing media device for OSD N 540A in placement group 1 510. A process similar to the one used to incrementally decrease weight for the previous OSD may be used to incrementally increase weight for the newly added OSD, so as to re-introduce the new storage media device into placement group 1 510. The weight on OSD N 520N can gradually be increased in conjunction with data being copied from the backup. Except in this case the backup rate and the user data rate can be balanced to ensure that neither processor usage exceeds any required limits, but the backup process can be accomplished quickly.

FIG. 11 is a physical representation of an intelligent storage media tray 350, according to embodiments of the present disclosure. Intelligent storage media tray 350 may provide indicators for server infrastructure 120.

As mentioned earlier, SoC 124 may set visual indicators or displays using any suitable display controller. As a result of the previous testing, these indicators may be set as follows. Visual indicator 362 may indicate that data replication is in progress or has completed. Visual indicator 364 may indicate that intelligent storage media tray 350 cannot be removed from the server, or that it can be removed from the server. Indicators 366 may indicate which storage device 358 (which may be implemented by devices 110) is undergoing remediation or has been isolated. Since the indicator 366 is positioned adjacent to the storage media 358, the specific indicator 366 may identify which specific storage device 358 that is affected.

Using the visual indicators 362, 364, 366 a technician can immediately be alerted to the ongoing testing and remediation processes.

Embodiments of the present disclosure may include a server.

The server may include a processor and a non-transitory machine-readable medium. The medium may include instructions. The instructions, when loaded and executed by the processor, may cause the processor to obtain SDS software defined storage (SDS) performance data from a plurality of media servers, process the SDS performance data, and determine whether the SDS performance data indicates that a first media server includes a potentially failing storage medium.

In combination with any of the above embodiments, processing the SDS performance data may include determining that the first media server includes a potentially failing storage medium based upon non-zero throughput rate, filesystem errors, and user data errors.

In combination with any of the above embodiments, the instructions may be further to cause the processor to create a risk footprint of failure of placement groups used by an SDS application to determine whether the first media server includes a potentially failing storage medium.

In combination with any of the above embodiments, the instructions may be further to cause the processor to dynamically adjust a storage media weight attribute to change data replication from the potentially failing storage medium.

In combination with any of the above embodiments, the instructions may be further to cause the processor to continue to add data to the potentially failing storage medium while using the potentially failing storage medium as a replica source to create a replica of the potentially failing storage medium.

In combination with any of the above embodiments, the instructions may be further to cause the processor to dynamically adjust the storage media weight attribute based on a dynamic evaluation of a plurality placement group risk footprints.

Embodiments of the present disclosure may include an article of manufacture. The article of manufacture may include any of the non-transitory machine-readable media of the above embodiments.

Embodiments of the present disclosure may include methods performed by any of the servers or processors of the above embodiments.

Although example embodiments have been described above, other variations and embodiments may be made from this disclosure without departing from the spirit and scope of these embodiments.

We claim:

1. A server, comprising:
a processor; and
a non-transitory machine-readable medium including instructions, the instructions, when loaded and executed by the processor, cause the processor to:
obtain software defined storage (SDS) performance data from a plurality of media servers;
process the SDS performance data; and
determine whether the SDS performance data indicates that a first media server includes a potentially failing storage medium.

2. The server of claim 1, wherein processing the SDS performance data includes determining that the first media server includes a potentially failing storage medium based upon non-zero throughput rate, filesystem errors, and user data errors.

3. The server of claim 1, wherein the instructions are further to cause the processor to create a risk footprint of failure of placement groups used by an SDS application to determine whether the first media server includes a potentially failing storage medium.

4. The server of claim 1, wherein the instructions are further to cause the processor to dynamically adjust a storage media weight attribute to change data replication from the potentially failing storage medium.

5. The server of claim 1, wherein the instructions are further to cause the processor to continue to add data to the potentially failing storage medium while using the potentially failing storage medium as a replica source to create a replica of the potentially failing storage medium.

6. The server of claim 4, wherein the instructions are further to cause the processor to dynamically adjust the storage media weight attribute based on a dynamic evaluation of a plurality placement group risk footprints.

7. An article of manufacture, comprising a non-transitory machine-readable medium including instructions, the instructions, when loaded and executed by a processor, cause the processor to:
obtain software defined storage (SDS) performance data from a plurality of media servers;
process the SDS performance data; and
determine whether the SDS performance data indicates that a first media server includes a potentially failing storage medium.

8. The article of claim 7, wherein processing the SDS performance data includes determining that the first media server includes a potentially failing storage medium based upon non-zero throughput rate, filesystem errors, and user data errors.

9. The article of claim 7, wherein the instructions are further to cause the processor to create a risk footprint of failure of placement groups used by an SDS application to determine whether the first media server includes a potentially failing storage medium.

10. The article of claim 7, wherein the instructions are further to cause the processor to dynamically adjust a storage media weight attribute to change data replication from the potentially failing storage medium.

11. The article of claim 7, wherein the instructions are further to cause the processor to continue to add data to the potentially failing storage medium while using the potentially failing storage medium as a replica source to create a replica of the potentially failing storage medium.

12. The article of claim 11, wherein the instructions are further to cause the processor to dynamically adjust the storage media weight attribute based on a dynamic evaluation of a plurality placement group risk footprints.

13. A method, comprising:
obtaining software defined storage (SDS) performance data from a plurality of media servers;
processing the SDS performance data; and
determine whether the SDS performance data indicates that a first media server includes a potentially failing storage medium.

14. The method of claim 13, wherein processing the SDS performance data includes determining that the first media server includes a potentially failing storage medium based upon non-zero throughput rate, filesystem errors, and user data errors.

15. The method of claim 13, comprising creating a risk footprint of failure of placement groups used by an SDS application to determine whether the first media server includes a potentially failing storage medium.

16. The method of claim 13, comprising dynamically adjusting a storage media weight attribute to change data replication from the potentially failing storage medium.

17. The method of claim 13, comprising continuing to add data to the potentially failing storage medium while using the potentially failing storage medium as a replica source to create a replica of the potentially failing storage medium.

18. The method of claim 17, comprising dynamically adjusting the storage media weight attribute based on a dynamic evaluation of a plurality placement group risk footprints.
